(19) United States
(12) Patent Application Publication
(10) Pub. No.: US 2016/0208568 A1
(43) Pub. Date: Jul. 21, 2016

(54) Press for Drill Cuttings

(71) Applicant: Strive Energy Services Inc., Calgary (CA)

(72) Inventor: Ian BARNETT, Sundre (CA)

(21) Appl. No.: 15/000,734

(22) Filed: Jan. 19, 2016

Related U.S. Application Data
(60) Provisional application No. 62/105,568, filed on Jan. 20, 2015.

(51) Int. Cl. E21B 21/06; B30B 9/04

(52) U.S. Cl. CPC E21B 21/066; B30B 9/04

(57) ABSTRACT

A press comprising a body, the body containing a chamber interposed between a ram and an end wall, the ram connected to a piston to compact material against the end wall to generate a pressed object, the chamber comprising an opening for loading the material into the chamber, and a series of perforations to enable liquid contained in the material to be expelled from the chamber during advancement of the piston towards the end wall.

This application claims priority to U.S. Provisional Patent Application No. 62/105,568 filed on Jan. 20, 2015, the contents of which are incorporated herein by reference.

### TECHNICAL FIELD

The following relates to a method and apparatus for pressing drill cuttings to remove drilling mud and prepare the drill cuttings for disposal.

### DESCRIPTION OF THE RELATED ART

Drilling processes used in various industries such as oil and gas and mining use drilling fluids to lubricate and cool the drill bit, and to carry drilled cuttings out of the bore hole. Drilling fluids can also be used to drive downhole mud motors. Drilling fluids, also known as “mud” can be expensive. Solids control systems are often incorporated into the drilling process to remove solids in an effort to reuse at least some recovered mud in subsequent drilling operations.

For example, shale shakers are well known machines that are often used as the primary solids separation equipment on a drilling site. A mixture of drilling fluid and drill cuttings that is brought to the surface during the drilling operation flows into one or more shale shakers to be processed. Once processed, recovered mud is fed to a mud tank for further processing to remove finer solids before being reused by the drilling equipment. The solids removed by the shale shaker are discharged for further treatment or disposal. The shale shaker separates the mud from the cuttings using a shaker basket having a screen that allows mud to collect in the mud tank as the mud and cuttings are fed over the screen while the shaker basket is vibrated.

The drill cuttings that are discharged from the shale shaker typically need to be treated to meet environmental or other regulations, as well as to make them suitable for transporting away from the drilling site. For example, drill cuttings can be mixed with wood shavings to create a dry enough product to be hauled away for disposal.

### SUMMARY

In one aspect, there is provided a press comprising a body, the body containing a chamber interposed between a ram and an end wall, the ram connected to a piston to compact material against the end wall to generate a pressed object, the chamber comprising an opening for loading the material into the chamber, and a series of perforations to enable liquid contained in the material to be expelled from the chamber during advancement of the piston towards the end wall.

In another aspect, there is provided a system for recovering drilling fluid from drill cuttings, the system comprising: a first collection tank for collecting drill cuttings output from a shale shaker; a conveyance system for conveying the drill cuttings to a press; the press comprising a body, the body containing a chamber interposed between a ram and an end wall, the ram connected to a piston to compact the drill cuttings against the end wall to generate a pressed object, the chamber comprising an opening for loading the drill cuttings into the chamber, and a series of perforations to enable drilling fluid contained in the drill cuttings to be expelled from the chamber during advancement of the piston towards the end wall; and a second collection tank for collecting the pressed objects.

In yet another aspect, there is provided a method of recovering drilling fluid from drill cuttings, the method comprising: collecting drill cuttings in a chamber, the chamber being interposed between a ram operated by a piston and an end wall of a press; advancing the piston towards the end wall to compact the drill cuttings; reversing the piston after the drill cuttings are compacted to generate a pressed cutting; opening an end cap comprising the end wall; and advancing the piston towards the pressed cutting to expel the pressed cutting from the chamber. The method can also include reversing the piston and closing the end cap.

### BRIEF DESCRIPTION OF THE DRAWINGS

Embodiments will now be described by way of example only with reference to the appended drawings wherein:

FIG. 1 is a schematic diagram of a drilling fluid recovery system;

FIG. 2 is a schematic elevation view of a drill cuttings press integrated with a shale shaker;

FIG. 3 is a flow chart illustrating a process for operating the drill cuttings press shown in FIG. 2;

FIGS. 4(a) to 4(f) are sectional schematic views illustrating operation of a drill cuttings press; and

FIG. 5 is a plan view of a drill cuttings press having multiple processing chambers.

### DETAILED DESCRIPTION

Additional mud can be extracted from drill cuttings and the drill cuttings can be processed into a transportable form, without mixing in additional materials, by pressing “wet” drill cuttings processed by a shale shaker in a press having perforations at a compaction end. In this way, the press squeezes excess drilling mud from the wet cuttings to further improve mud recovery while removing moisture from the cuttings. At the same time, the cuttings are compacted into a block to facilitate disposal. It has been found that the resulting block is dry enough for immediate transport, i.e., without needing to be mixed with additional materials such as wood shavings. The additional mud that is squeezed from the press can also be fed back into the mud system for further processing if necessary before being reused in the drilling system.

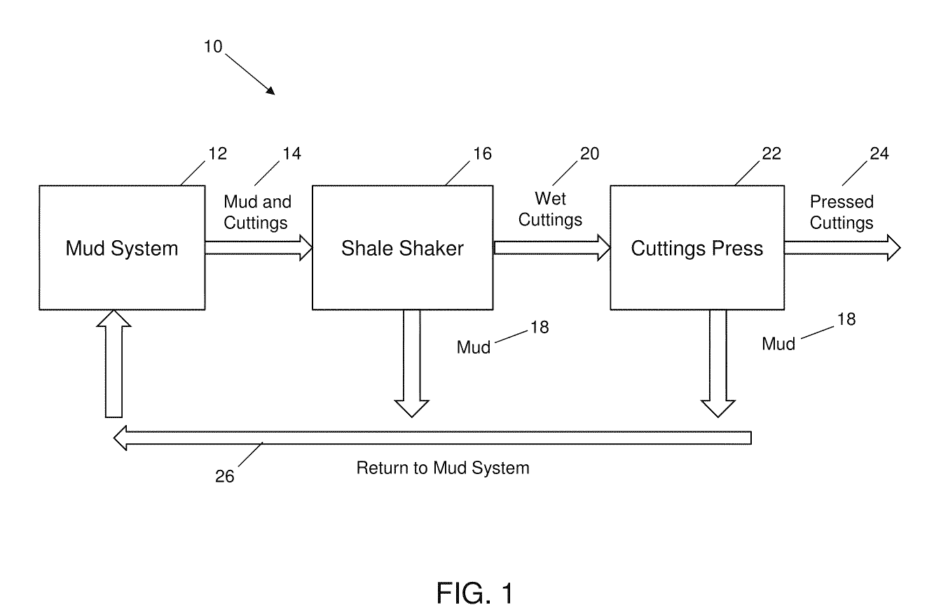

Turning now to FIG. 1, a drilling fluid recovery system 10 is shown, which can be operated with a mud system 12 used in a drilling process. The mud system 12 operates to provide lubrication, cooling, and even propulsion for down hole drilling equipment such as a drill bit, mud motor, etc. As the drilling fluid or “mud” circulates through the drilling system, drill cuttings produced by the drilling process are carried back up to surface. The mud system 12 therefore generates a mixture of mud and drill cuttings 14 that need to be treated and/or disposed of.

As discussed above, it is typical to use a shale shaker 16 as a primary solid recovery tool in a drilling process. The mixture of mud and cuttings 14 flows into the shale shaker 16 to separate recoverable mud 18 from generally “wet” cuttings 20 (i.e. cuttings that are at least in part containing some drilling fluid). The recoverable mud 18 may require further processing to remove finer particulate, and can be fed into a mud system return 26 in order to be reused.

It has been recognized that rather than mixing the wet cuttings 20 with materials such as wood shaving to enable transport, the wet cuttings 20 can be further processed to remove the remaining mud 18 by pressing the wet cuttings 20 in a cuttings press 22. The cuttings press 22 squeezes the wet cuttings 20 to further extract recoverable mud 18 and therefore increase the amount of mud 18 that is reused by the mud system 12. Furthermore, the pressed cuttings 24 are found to be dry enough for transport, which can save an additional processing step to dry out the material. For example, the pressed cuttings 24 can be deposited directly into a container for removal, transport, etc.

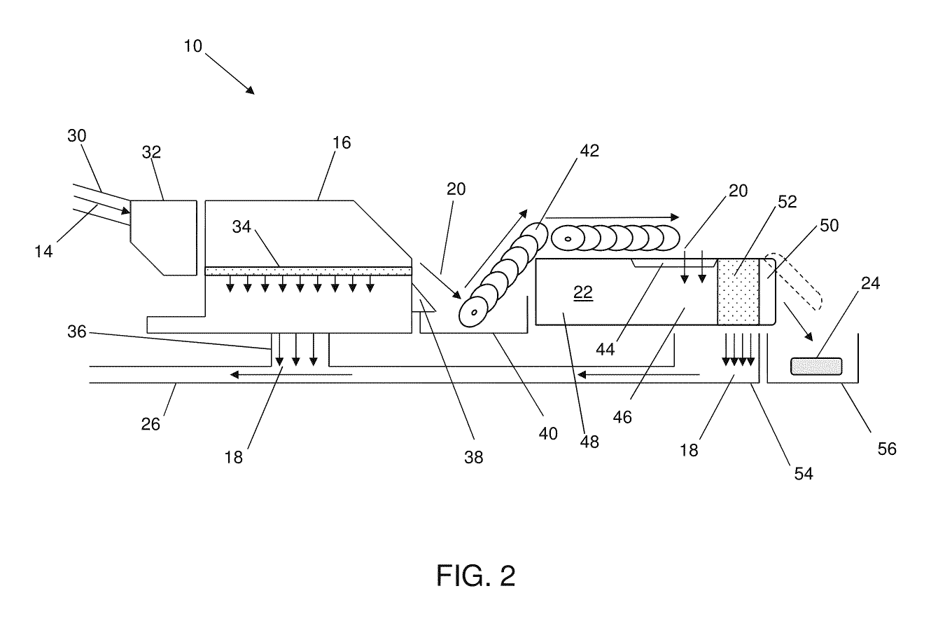

FIG. 2 illustrates an example of a configuration for the cuttings press 22 when integrated with a shale shaker 16. Mud and cuttings 14 are fed into a hopper 32 via a flow line 30. The hopper 32 feeds the mud and cuttings 14 onto a screen bed 34, which is operated by a vibrator (not shown) to separate mud 18 from drill cuttings 20 as is known in the art. In this example configuration, the separated mud 18 flows through a mud return 36 to a main mud system return line 26.

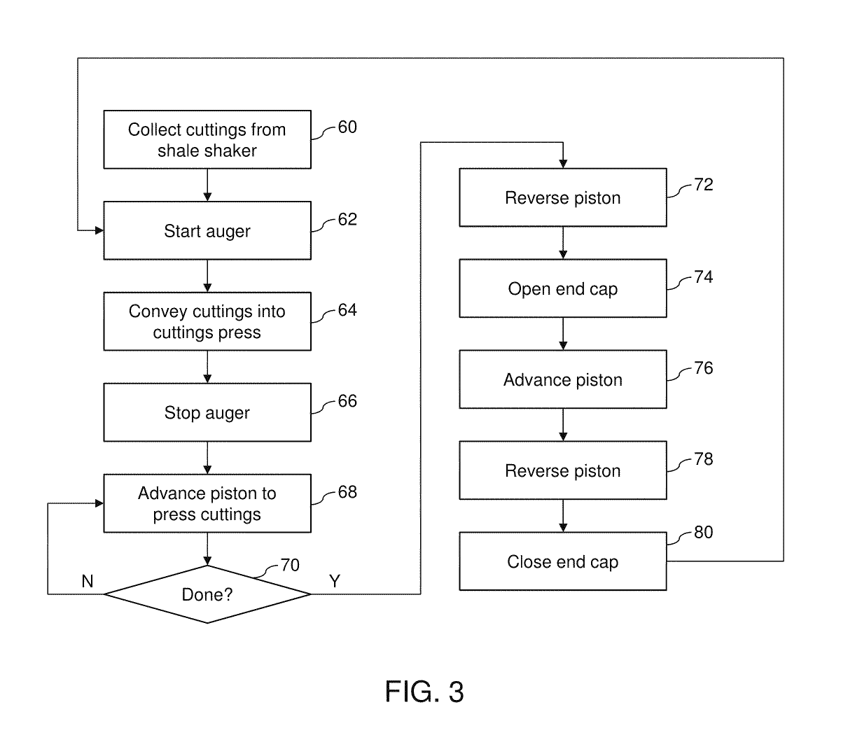

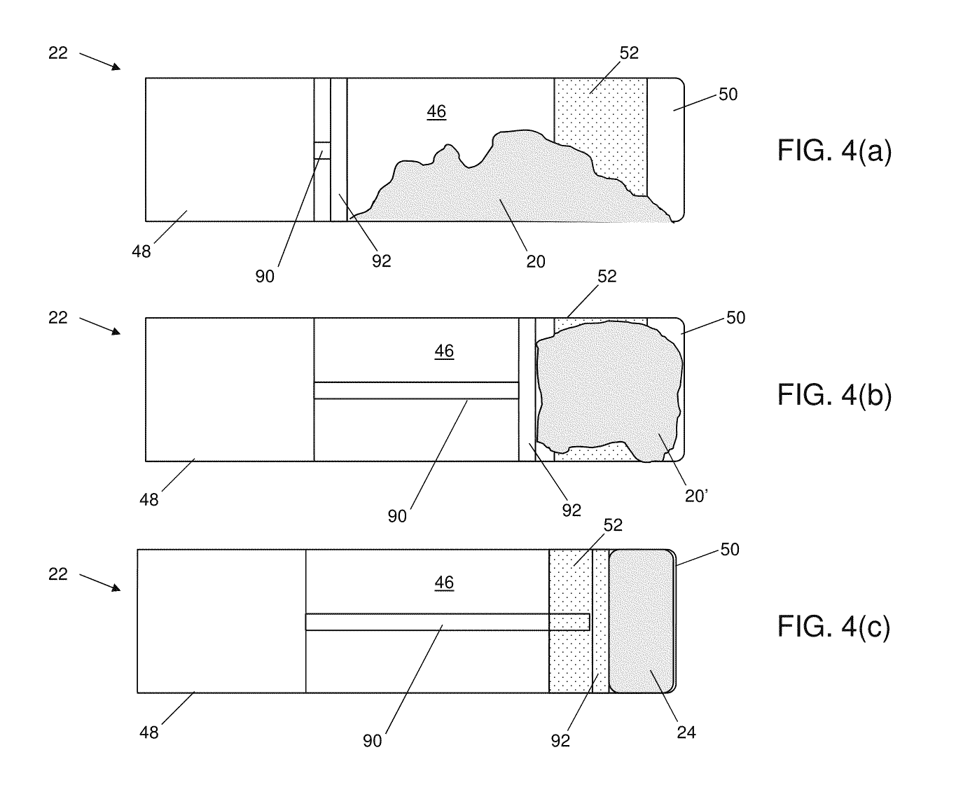

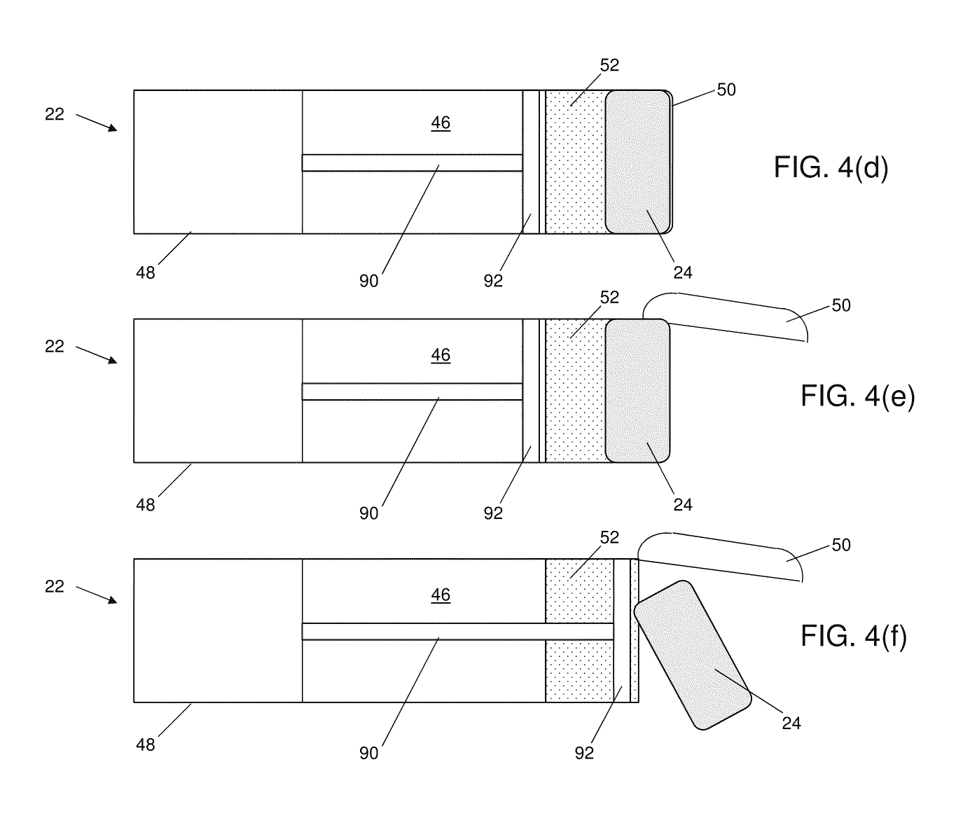

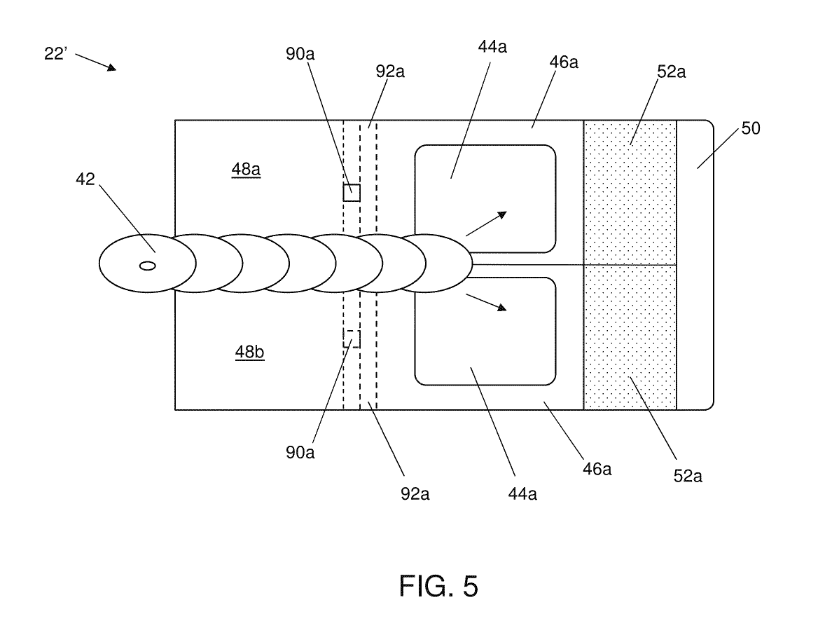

The wet cuttings 20 that exit the shale shaker 16 typically proceed down a shale slide 38, and are collected in a cuttings collection tank 40. A conveyance system 42 such as a series of augers is used to convey the wet cuttings 20 from the collection tank 40 up and towards an opening 44 in the press's body, which allows the wet cuttings 20 to collect within a chamber 46. A cylinder 48 houses a piston 90 and operates a ram 92 (see FIG. 4) to press the collected cuttings 20 within the chamber 46 and towards an end cap 50. Near the end cap 50, the chamber 48 includes a series of holes or perforations to provide a screen for mud 18 to be squeezed from the wet cuttings 20 and exit the chamber 48. For example, 1/16 inch holes have been found to be suitable. The squeezed mud 18 is collected in a fluid collection tank 54. The squeezed mud 18 can then be fed into the mud system return 26, e.g., for further processing using a centrifuge (not shown) or other equipment used to remove finer particulate matter so that the squeezed mud 18 can be reused. The pressed cuttings 24 are then discharged, as discussed in greater detail below, into a cuttings disposal tank 56. It has been found that a piston 90 that can deliver 62 tonnes of pressure, and a 14 ½″ inside diameter for the chamber 48 are suitable for extracting the additional mud 18 in the configuration shown herein, although other operating pressures and chamber sizes are possible within the principles discussed herein.

FIG. 3 illustrates operations that can be performed in order to press wet cuttings 20 and generate pressed cuttings 24 and additional mud 18 using the configuration shown in FIG. 2. At 60, wet cuttings 20 are collected from the shale shaker 16 in the cuttings collection tank 40. Once cuttings 20 have accumulated in the cuttings collection tank 40, the auger or other conveyance system 42 is started at 62 to begin conveying the cuttings 20 into the cuttings press chamber 46 at 64 (with the piston 90 and ram 92 retracted). After the chamber 46 has been loaded with at least enough cuttings 20 to form a pressed cutting 24, the auger is stopped at 66. The chamber 46 therefore includes a pile of wet cuttings 20 therewithin as shown in FIG. 4(a). As also shown in FIG. 4(a), the cylinder 48 houses a piston 90, which drives a ram 92 to compress the wet cuttings 20 within the chamber 46. The piston 90 is driven at 68 to press the cuttings as shown in FIG. 4(b). This operation continues until it is determined at 70 that the pressing operation is done. As the piston 90 presses the wet cuttings 20 to form a pressed cutting 24, excess mud is squeezed out of the press 26 through the perforations 52 to be collected in the fluid collection tank 54. When the compaction operation is complete (i.e. after at least some fluid has been expelled from the press 26), as shown in FIG. 4(c), the piston 90 can be reversed at 72, which is also illustrated in FIG. 4(d) to release pressure on the end cap 50. The end cap 50 is then opened at 74, as shown in FIG. 4(e), which enables the piston 90 to be advanced at 76 to discharge the pressed cutting 24 as shown in FIG. 4(f). The piston 90 is then reversed again at 78 to a start position (e.g., fully retracted), and the end cap 50 is closed at 80 to allow for the process to be repeated by starting the auger again at 62 to convey more wet cuttings 20 into the press chamber 48.

While a particular configuration is shown in FIGS. 2 and 4, and exemplary operations are shown in FIG. 3, various modifications are possible. For example, while shale shakers 16 are typical solid removal tools using in drilling processes, the press 22 described herein can be used with any suitable machine that generates wet cuttings 20 that are capable of being pressed. For example, the press 22 could be used instead of a shale shaker 16. Similarly, while a conveyance system 42 such as an auger is herein illustrated, manual methods for loading the wet cuttings 20 into the cuttings press 22 are equally possible. Moreover, the end cap 50 and its operation illustrated in FIG. 4 is only one way to remove the pressed cuttings from the press 22. For example, the pressed cuttings 24 can be manually removed without relying on operation of the piston 90. The end cap 50 can also be hinged at the bottom of the cuttings press 22, or a top or bottom release hatch (or other access mechanism) could be used, without departing from the principles described herein. The perforations 52 shown in FIGS. 2 and 4 are also illustrative only and may be implemented in other patterns and consume varying amounts of the outer surface of the cuttings press 22.

FIG. 5 illustrates a multi-chamber cuttings press 22′. In the example shown in FIG. 5, the conveyance system 42 feeds wet cuttings 20 into a first opening 44a and a second opening 44b to load a first chamber 46a and a second chamber 46b. First and second pistons 90 and rams 92 can be operated in tandem or independently to generate a pair of pressed cuttings 24 that can be discharged from a single end cap 50. It can be appreciated that a single end cap 50 as shown in FIG. 5 is only one option, i.e. multiple end caps 50 can also be employed. Moreover, more than two chambers 46 can also be used within the same system 10.

Although not shown in the figures, a control system can also be incorporated into the system 10 to automate the loading and pressing of the wet cuttings 20. Such a control system can be manually controlled or pre-programmed to cycle through stages of loading material, pressing material, and expelling pressed material, e.g., by turning augers on or off, and opening the end cap 50 using a servo-motor or other electromechanical device. For example, such a control system can be programmed to control the system 10 substantially as shown in FIG. 3. That is, at least some of the operations shown in FIG. 3 can be adapted for automated control using computer executable instructions.

It will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

The examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A press comprising a body, the body containing a chamber interposed between a ram and an end wall, the ram connected to a piston to compact material against the end wall to generate a pressed object, the chamber comprising an opening for loading the material into the chamber, and a series of perforations to enable liquid contained in the material to be expelled from the chamber during advancement of the piston towards the end wall.

2. The press of claim 1, wherein the end wall is provided by an end cap coupled to the chamber, the end cap movable to provide an opening into the chamber to expel the pressed object.

3. The press of claim 2, wherein the end cap is rotatably attached to the chamber.

4. The press of claim 1, wherein the chamber comprises an access mechanism adjacent the end wall to facilitate removal of the pressed object.

5. The press of claim 1, further comprising at least one additional chamber and at least one additional piston for compacting the material within both chambers.

6. The press of claim 5, comprising a single end cap for both the chamber and the at least one additional chamber.

7. The press of claim 1, wherein the pressed object comprises drill cuttings and at least some fluid to be expelled through the series of perforations.

8. A system for recovering drilling fluid from drill cuttings, the system comprising:
a first collection tank for collecting drill cuttings output from a shale shaker;
a conveyance system for conveying the drill cuttings to a press;
the press comprising a body, the body containing a chamber interposed between a ram and an end wall, the ram connected to a piston to compact the drill cuttings against the end wall to generate a pressed object, the chamber comprising an opening for loading the drill cuttings into the chamber, and a series of perforations to enable drilling fluid contained in the drill cuttings to be expelled from the chamber during advancement of the piston towards the end wall; and
a second collection tank for collecting the pressed objects.

9. The system of claim 8, further comprising a third collection tank for collecting expelled drilling fluid.

10. The system of claim 9, wherein the third collection tank is connected to a mud system.

11. The system of claim 8, wherein the conveyance system comprises at least one auger.

12. The system of claim 8, wherein the end wall is provided by an end cap coupled to the chamber, the end cap movable to provide an opening into the chamber to expel the pressed object.

13. The system of claim 12, wherein the end cap is rotatably attached to the chamber.

14. The system of claim 8, wherein the chamber comprises an access mechanism adjacent the end wall to facilitate removal of the pressed object.

15. The system of claim 8, further comprising at least one additional chamber and at least one additional piston for compacting the drill cuttings within both chambers.

16. A method of recovering drilling fluid from drill cuttings, the method comprising:
collecting drill cuttings in a chamber, the chamber being interposed between a ram operated by a piston and an end wall of a press;
advancing the piston towards the end wall to compact the drill cuttings;
reversing the piston after the drill cuttings are compacted to generate a pressed cutting;
opening an end cap comprising the end wall; and
advancing the piston towards the pressed cutting to expel the pressed cutting from the chamber.

17. The method of claim 16, further comprising:
reversing the piston; and
closing the end cap.

18. The method of claim 16, further comprising:
collecting the drill cuttings from a shale shaker;
operating a conveyance system to move drill cuttings into the chamber; and
stopping operation of the conveyance system prior to driving the piston.

19. The method of claim 16, further comprising detecting that the drill cuttings are sufficiently compacted prior to reversing the piston.
